(19) United States
(12) Patent Application Publication
(10) Pub. No.: US 2014/0076854 A1
(43) Pub. Date: Mar. 20, 2014

(54) Gas Circuit Breaker

(71) Applicant: Hitachi, Ltd., Tokyo (JP)

(72) Inventors: Kenichi OKUBO, Tokyo (JP); Hiroaki HASHIMOTO, Tokyo (JP)

(73) Assignee: Hitachi, Ltd., Tokyo (JP)

(21) Appl. No.: 13/972,547

(22) Filed: Aug. 21, 2013

(30) Foreign Application Priority Data
Sep. 18, 2012 (JP) 2012-203846

(51) Int. Cl. H01H 3/46

(52) U.S. Cl. CPC H01H 3/46
USPC 218/154

(57) ABSTRACT

A gas circuit breaker that includes a fixed contact, a moving contact to contact or separate from the fixed contact, an enclosed container containing the fixed contact and moving contact and filled with insulating gas, and an operating device to drive the moving contact. The operating device contains an elastic piece for a drive source, and a control mechanism to hold and release the elastic piece, and a link mechanism to transmit the drive force from the elastic piece to the moving contact. The elastic piece contains an opening spring and a closing spring. The opening spring is mounted between the link mechanism and the control mechanism with the operating axis oriented horizontally.

### TECHNICAL FIELD

The present invention relates to a gas circuit breaker and relates in particular to a gas circuit breaker featuring a low-height design and improved operational stability.

### BACKGROUND

Operating devices for gas circuit breakers typically include pneumatic-operated devices and hydraulic-operated devices utilizing air or hydraulic pressure and that obtain an operating force from the release of compressive force by an elastic piece such as a spring.

One example of a gas circuit breaker utilizing a spring for the drive source is disclosed in Japanese Unexamined Patent Application Publication No. 2011-29004. In this gas circuit breaker, an enclosed container, link mechanical section, and operating device are mounted horizontally adjacent to each other, and form a gas seal chamber connecting to the enclosed container and mounted between the enclosed container and operating device. This type of gas circuit breaker structure has the object of providing a gas circuit breaker capable of efficiently reducing leakage of insulating gas within the enclosed container along with the height dimensions.

Another example of a gas circuit breaker utilizing a spring for the drive source is disclosed in Japanese Unexamined Patent Application Publication No. 2007-294363. This gas circuit breaker structure has the object of providing a gas circuit breaker with a good overall balance in a compact shape by way of a design where the center axis of the tank and the center of the spring operation apparatus largely match each other. This gas breaker structure also includes better maintenance-inspection features and improved operability of the operating device by changing the mounting positions such as for the auxiliary control devices in the spring operating mechanism as needed according to the structure of the gas circuit breaker.

### SUMMARY

However, the structures disclosed in the Japanese Unexamined Patent Application Publication No. 2011-29004 and Japanese Unexamined Patent Application Publication No. 2007-294363 had the problem that the operating directions of the spring for the drive source and the breaker section contact point crossed each other, so that the link mechanism had a complicated structure and there was less energy efficiency for driving the breaker section contact point.

Moreover, the spring operation apparatus was supported on one end in an enclosed container so that the vibration in the spring operation apparatus was large during gas circuit breaker operation which exerted adverse effects on the reliability of the gas circuit breaker.

Further, when the gas circuit breakers disclosed in Japanese Unexamined Patent Application Publication No. 2011-29004 and Japanese Unexamined Patent Application Publication No. 2007-294363 utilized a large spring to increase the device capacity, which might require making the gas circuit breaker larger due to having to enlarge the spring intersecting the operating axis of the gas circuit breaker.

In order to address the aforementioned problems, the present invention provides a gas circuit breaker capable of achieving stable operability with a compact shape by limiting the overall height.

According to an aspect of the present invention, the gas circuit breaker includes a fixed contact; a moving contact to contact or to separate from the fixed contact; an enclosed container sealed with insulating gas and internally containing the fixed contact and the moving contact; and an operating device to drive the moving contact. The operating device includes an elastic piece for the drive source; a control mechanism to hold and to release the elastic piece; and a link mechanism to transmit the driving force of the elastic piece to the moving contact. The elastic piece includes an opening action elastic piece and a closing action elastic piece. The opening action elastic piece is placed between the link mechanism and the control mechanism with the operating axis oriented horizontally.

According to the present invention, aligning the operating direction of the opening spring of the drive source approximately in the operating axis direction of the moving contact, allows simplifying the link mechanism between the opening spring and moving contact so that the present invention can limit the overall height of the gas circuit breaker and the gas insulated switch and also improve the energy efficiency for driving the moving contact.

Moreover, connecting an output link for swinging the change lever to the moving end of an opening spring allows limiting the length of the link installed between the opening spring and moving contact so that the energy efficiency for driving the moving contact can be improved.

Also, clamping the enclosed container and the spring operation apparatus to the common base of the gas circuit breaker allows limiting the vibration transmitted to spring operating apparatus during operation of the gas circuit breaker so that the operational safety of the gas circuit breaker can be improved.

### BRIEF DESCRIPTION OF THE DRAWINGS

FIG. 1 is a side view showing the on state of the breaker section in the gas circuit breaker of a first embodiment; the operating device section is a cross sectional view, and shows the clamped side and moving side of the gas circuit breaker divided by a solid line. The same is also true for FIG. 2, FIG. 3, and FIG. 5 (solid and dotted lines);

FIG. 2 is a side view showing the off state of the breaker section in the gas circuit breaker of the first embodiment;

FIG. 3 is a side view showing the state where the breaker section has shifted from the state in FIG. 2 to the on state in the gas circuit breaker of the first embodiment;

FIG. 4 is a detailed view showing the manual handle for controlling the output transmission lever and the dash pot mounted in the vicinity of the opening spring; and

FIG. 5 is a side view showing the on state of the breaker section in the gas circuit breaker of a second embodiment.

### DETAILED DESCRIPTION

The preferred embodiments of the present invention are described next while referring to the drawings. The following embodiments are only examples and do not intentionally indicate limits on the content of the invention in the following specific states. The invention itself of course is capable of being rendered in a diverse range of variations within the range satisfying the range of the claims.

### First Embodiment

The first embodiment is described while referring to the drawings. A gas circuit breaker 4 is comprised of an enclosed container 7 including a breaker section, a spring operation apparatus 2, and a mechanical section 15 connecting the spring operation apparatus 2 and enclosed container 7. The enclosed container 7 connects to the common base 1 by way of the base points 5a, 5b, and insulating gas such as SF₆ is filled into the tanks at a specified pressure.

Within the enclosed container 7, electrical conduction is made by way of a breaker section contact point comprised of a moving contact 12 and a fixed contact 11 by way of a conductor not shown in the figure. An insulated link 13 is connected to the moving contact 12 on the side opposite where contacting the fixed contact 11. The drive force of the spring operation apparatus 2 functions by way of the mechanical section 15 in this insulated link 13 to open and close the breaker section contact point.

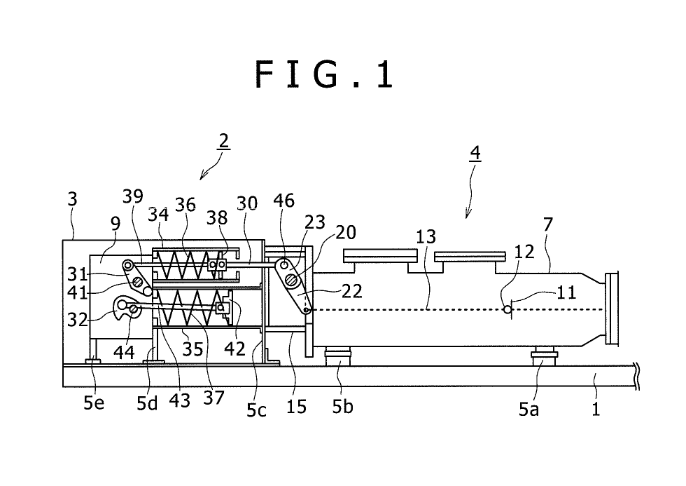

In FIG. 1, the moving contact 12 is in a state where contacting the fixed contact 11 or in other words the breaker section contact point is in the on state. Electrical power in this way conducts from the bus line to the feed line circuit side. If abnormal current flows in the system such as due to lightning during this electrical power conduction state a shutoff command is input to the gas circuit breaker 4, causing the moving contact 12 to separate from the fixed contact 11 to shut off the electrical current.

The mechanical section 15 is connected to the flange of the enclosed container 7 at the extending tip of the insulated link 13. The mechanical section 15 contains a rotating shaft 20, and a lever in gas 22, and lever in air 23 clamped to the rotating shaft 20.

A gas sealed chamber and atmospheric chamber not shown in the drawings are mounted connecting to the enclosed container 7 in the mechanical section 15. These chambers both support the rotating shaft 20 that penetrates through both chambers and include a gas sealing scheme not shown in the drawings. The lever in gas 22 is connected on the gas sealing chamber side and the lever in air 23 is connected on the atmospheric chamber side of the rotating shaft 20. An insulated link 13 is connected on one end of the lever in gas. The output link 30 connects from the spring operation apparatus 2 on one end of the lever in air 23 and freely rotates via the pin 46.

The lever in gas 22 and the lever in air 23 are not limited to being mounted in the mechanical section 15 and may be mounted inside the enclosed container 7. Moreover, the gas sealing chamber and atmospheric chamber were partitioned by the rotating shaft 20 but the invention is not limited to this method and the chambers may be partitioned by a direct-acting section such as the output link 30.

The structure of the spring operation apparatus 2 is described next. The spring operation apparatus 2 is connected to the mechanical section 15 by way of the clamping plate 5c and also connects to the common base 1. The base points 5d, 5e also connect to the common base 1.

A cylindrical opening spring case 34 and closing spring case 35 are clamped to a case 9 inside the operating box 3 within the spring operation apparatus 2. The closing spring case 35 is clamped to a clamping plate 5c at the opposite end connecting to the case 9. The opening spring 36 and closing spring 37 are each arranged within these two spring cases.

Both springs are shown in a compressed state in FIG. 1. One end of the opening spring 36 is supported by the case 9, and the other end is supported by the supporting plate for the opening spring 38. One end of the opening spring link 39 is connected to one end of the supporting plate for the opening spring 38. The other end of the opening spring link 39 is coupled to the main lever 31. The center section of the main lever 31 is clamped to the rotating shaft 41 supported in the case 9 to allow free rotation.

The other end of the opening spring bearing 38 is connected to one end of the output link 30. Comparing this structure of the present embodiment to the structure in Japanese Unexamined Patent Application Publication No. 2011-29004 shows that coupling the output link 30 from the main lever 31 of the operating device to the lever in air 23 requires a long output link 30 so that the cross-sectional secondary moment of the output link 30 in the structure in Japanese Unexamined Patent Application Publication No. 2011-29004 had to be increased larger than that of the present embodiment in order to avoid buckling when a steep compressive load was applied.

However during breaker operation in the present embodiment, even if a sharp compressive load is applied to the output link 30, compared to the structure disclosed in Japanese Unexamined Patent Application Publication No. 2011-29004 the output link 30 of the present embodiment can be kept short as shown in FIG. 1 so that the buckling in the output link 30 can be reduced. The reliability of the operating device can in this way be enhanced.

The output link 30 is shown as one member in the figure; however, a structure utilizing two or more members joined by a turnbuckle may be utilized and the wipe dimension of the breaker section can be adjusted in this way.

The opening spring 36 is mounted with the operating axis oriented horizontally, and the opening spring 36 operating axis is more preferably mounted approximately parallel to the operating axis of the moving contact 12.

Utilizing this type of structure, allows simplifying the link mechanism that transmits the drive force of the operation device to the moving contact compared to the structure in the Japanese Unexamined Patent Application Publication No. 2011-29004 and Japanese Unexamined Patent Application Publication No. 2007-294363 where the operating axis of the opening spring approximately intersects the operating axis of the moving contact, so that the drive force of the spring operation apparatus 2 can efficiently be transmitted to the moving contact 12.

There are no particular restrictions on the position where the closing spring 37 is mounted. The closing spring 37 may for example be mounted on the upper side or the lower side of the opening spring 36 and even on the side surface, however to improve the earthquake resistance and achieve a low center of gravity for the breaker, the closing spring 37 is preferably mounted below the opening spring 36 or still more preferably perpendicularly below the opening spring 36.

As shown in FIG. 1, the closing spring 37 in the spring operation apparatus 2 is supported on one end by the case 9 and on the other end by the closing spring bearing 42. One end of the closing spring link 43 is connected to the closing spring bearing 42. A cam 32 is connected for free rotation to the other end of the closing spring link 43. The cam 32 is clamped to the rotating shaft 44 supported for free rotation in the case 9.

In the spring operation apparatus 2, a gear mechanism and motor not shown in the figure are mounted in the case 9 for recompression after the closing spring 37 has been released in the contact point closing operation. A control mechanism to hold and release the drive force of the compressed closing spring and opening spring is also mounted in the case 9.

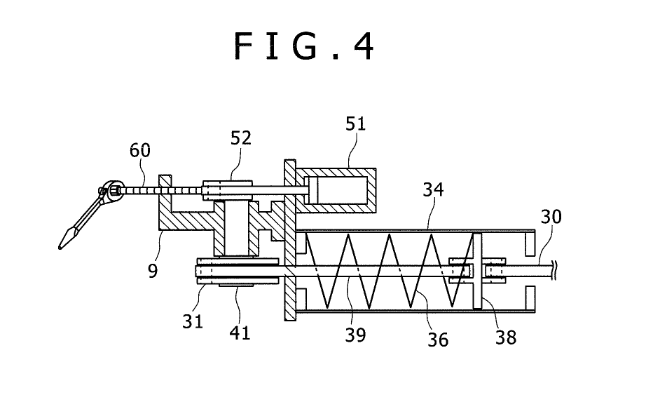

The opening spring 36 is coupled to a dash pot 51 by way of a main lever 31, a rotating shaft 41, and a dash pot output lever 52 (FIG. 4). The dash pot output lever 52 is mounted adjacently on the side opposite the main lever 31 of the case 9, and a manual handle 60 is mounted on the dash pot output lever 52 passing through the case 9 and extending outward from the case 9.

When closing the breaker section contact points manually is necessary in order to confirm the breaker section wipe dimension, turning the manual handle 60 to operate the dash pot output lever 52 can set the breaker section contact points to the on state simultaneous with accumulating power in the opening spring 36 by way of the main lever 31. The manual handle 60 is preferably removed except during manual operation.

This type of structure allows improved operability since the wipe quantity and other items can be easily checked by removing an operating box 3.

The operation of the gas circuit breaker 4 is described next while referring to FIG. 1 through FIG. 3. The operation to shift the breaker section contact points shown in FIG. 1 from the on state to the off state is first described. In FIG. 1, the contact point off operation begins when an opening signal is input to the gas circuit breaker 4.

Namely, in FIG. 1 the control mechanism for the opening spring operates to free the opening spring 36 from the compressed state and release the opening spring 36. The drive force of the opening spring 36 is transmitted to the output link 30 by way of the opening spring link 39, and the output link 30 is shifted towards the right edge of the paper.

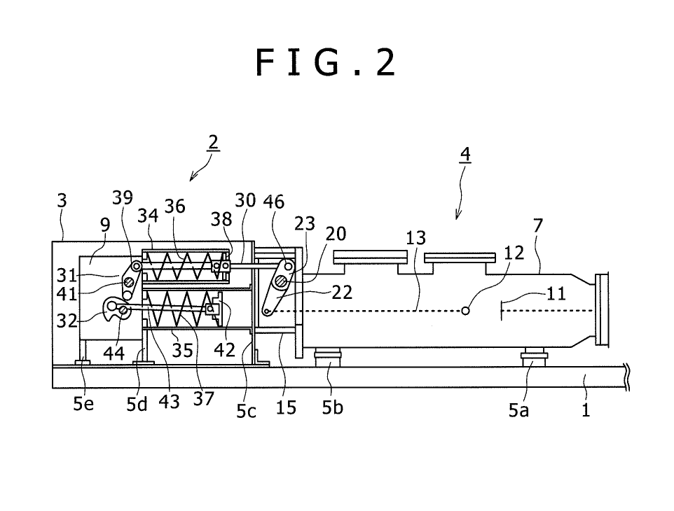

The lever in air 23 of the mechanical section 15 next rotates in the clockwise direction. The rotating shaft 20 also rotates clockwise, and the lever in gas 22 clamped to this rotating shaft 20 also moves in the clockwise direction. The insulated link 13 in this way is driven leftward on the paper surface of FIG. 1, the moving contact 12 of the breaker section contact point is moved leftward on the paper surface, and separates from the fixed contact 11. When the energy of the opening spring 36 is fully released, on the spring operation apparatus 2 as shown in FIG. 2, the off switching of the contact point ends, and one end of the main lever 31, makes largely direct contact with the outer circumferential surface of the closing cam 32 and stops.

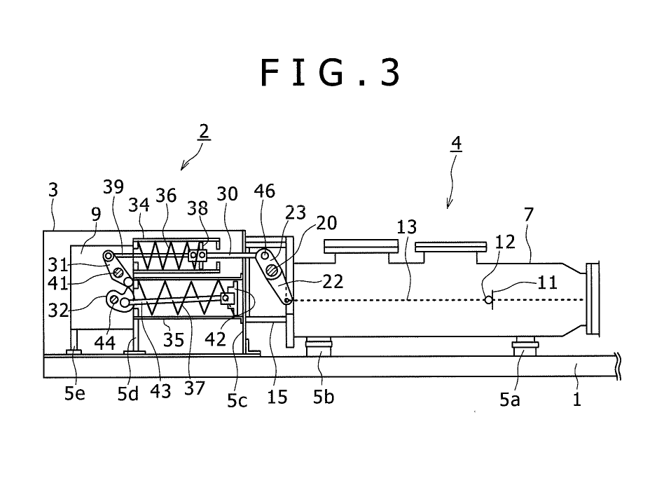

The operation for shifting the breaker section contact point from the off state shown in FIG. 2, to the contact point on state shown in FIG. 3 is described next. In the state shown in FIG. 2, inputting a closing signal to the gas circuit breaker 4 operates the control mechanism for the closing spring not shown in the figure, to release the closing spring 37 from the compressed state, and release the energy of the closing spring 37.

The cam 32 and the rotating shaft 44 are in this way moved in the clockwise direction by way of the closing spring link 43. The outer circumferential surface of the cam 32 presses against the outer circumferential surface of the main lever 31 along with the cam 32 movement and rotates the main lever 31 counterclockwise. The opening spring link 39 and the supporting plate for the opening spring 38 in this way compress the opening spring 36.

The output link 30 simultaneously moves leftward along the paper surface. The lever in air 23 and the lever in gas 22 in the mechanical section 15 in this way rotate in the clockwise direction and the insulated link 13 moves in the rightward along the paper surface. The moving contact 12 coupled to the insulated link 13 then moves rightward along the paper surface, contacts the fixed contact 11 to set the breaker section contact points to the on state. When release of the energy of the closing spring 37 is complete, the contact point operation shown in FIG. 3 ends.

From the state shown in FIG. 3 where the contact point on operation has ended, the released closing spring 37 is compressed by the motor and gear mechanism not shown in the drawing. The control mechanism retains the drive force of the closing spring 37 and operation shifts to the state shown in FIG. 1.

The insulating gas sealed inside the gas circuit breaker shown in the present embodiment is not limited to SF₆ and for example a gas mixture of SF₆ and N₂, CF₄ or CO₂ gas and so on may be utilized as the substitute gas instead of SF₆.

Compressed coil springs are utilized for both the opening spring and a closing spring in the spring operation apparatus of the gas circuit breaker shown in the present embodiment. The present invention however is not limited to this arrangement and if a direct acting elastic piece such as a plate spring is utilized then the opening spring and a closing spring may be easily replaced. Moreover, the same effect as the present embodiment can be obtained even by utilizing a compressed coil spring as the main drive source and a torsion bar spring in a secondary drive source.

By placing the operating axis of the opening spring of the spring operation apparatus approximately parallel to the operating axis of the moving contact as employed in the present invention, the drive force of the spring operation apparatus can be transmitted by using a simple link mechanism so that the drive force of the spring operation apparatus is efficiently transmitted to the breaker section compared to a structure requiring a complicated link mechanism such as where the operating axis of the opening spring in the spring operation apparatus and operating axis of the moving contact directly cross each other.

Placing the operating axis of the spring for the drive source parallel to the operating axis of the moving contact, and connecting a link to swing the change lever to the right end side of the spring in the paper surface, allows limiting the length of the link and conveying the drive force of the spring to the moving contact by way of the simple link mechanism to improve the energy efficiency for driving the moving contact.

By respectively clamping the spring operation apparatus and the enclosed container onto a base, the adverse effects occurring in the spring operation apparatus due to vibration during the operation of circuit breaker opening can be reduced and the operating stability can be improved compared to the circuit breaker structure often used in the related art where the spring operation apparatus structure rises above the base while supported on leg in the enclosed container.

### Second Embodiment

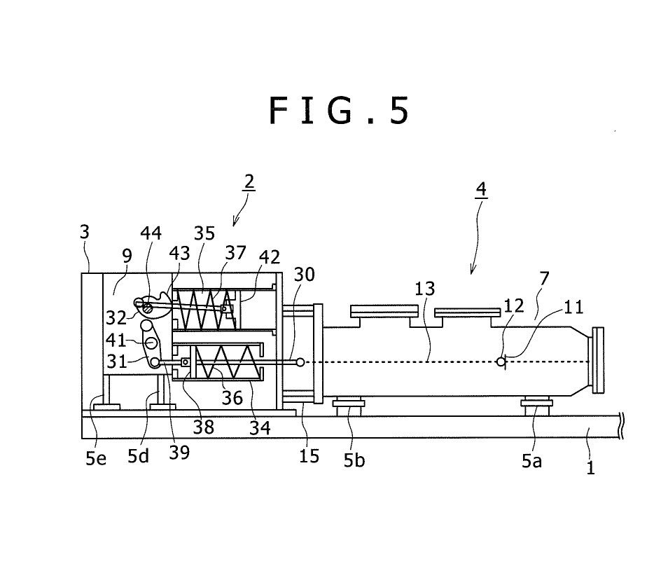

FIG. 5 shows the second embodiment of the present invention. The sections identical to the first embodiment are assigned the same reference numerals and a detailed description of those sections is omitted.

In the first embodiment, the spring operation apparatus 2 is connected to the insulated link 13 joined to the moving contact byway of a lever including a lever in gas 22 and lever in air 23. In the second embodiment however, these two levers are omitted and an output link 30 is directly connected to the insulated link 13. To achieve this structure, the operating axis of the opening spring 36 and the operating axis of the insulated link 13 are arranged in nearly a straight line.

Compared to the first embodiment, utilizing this type of structure allows transmitting the spring force of the opening spring to the moving contact linearly with good efficiency so that along with improving the breaking performance of the gas circuit breaker, the complicated link mechanism operation can be omitted so that the reliability of the gas circuit breaker is also improved.

There are moreover no particular restrictions on the mounting position of the closing spring 37 which may be mounted on the side above or below the opening spring 36 or on the side surface. Mounting the closing spring 37 below the opening spring 36 allows reducing the total height of the gas circuit breaker even further compared to the structure of the first embodiment so that in addition to the above described effects, a lower center-of-gravity and better earthquake resistance can be obtained.

What is claimed is:

1. A gas circuit breaker comprising:
a fixed contact;
a moving contact to contact or to separate a certain distance from the fixed contact;
an enclosed container filled with insulating gas and internally containing the fixed contact and the moving contact; and
an operating device to drive the moving contact,
wherein the operating device includes:
an elastic piece for the drive source;
a control mechanism to hold and release the elastic piece; and
a link mechanism to transmit the driving force of the elastic piece to the moving contact;
wherein the elastic piece includes an opening action elastic piece and a closing action elastic piece, and
the opening action elastic piece is placed between the link mechanism and the control mechanism with the operating axis oriented horizontally.

2. The gas circuit breaker according to claim 1,
wherein the operating axis of the opening action elastic piece is approximately parallel to the operating axis of the moving contact.

3. The gas circuit breaker according to claim 1,
wherein the operating axis of the opening action elastic piece and the operating axis of the moving contact are in a straight line.

4. The gas circuit breaker according to claim 1,
wherein the control mechanism includes an output transmission lever to transmit the drive force to a damper that alleviates the drive force on the rotating shaft of the main lever receiving the drive force from the opening action elastic piece, and
wherein the output transmission lever includes a manual handle on the edge of the control mechanism to control the position of the output transmission lever.
